(19) United States
(12) Patent Application Publication
(10) Pub. No.: US 2010/0194560 A1
(43) Pub. Date: Aug. 5, 2010

(54) SYSTEMS AND METHODS FOR ENHANCED BUSINESS PROCESS MONITORING

(75) Inventors: Edward Hojecki, Montville, NJ (US); Keith Scully, New York City, NY (US); Junlenon Ceria, Bergenfield, NJ (US); Richard Hufnagle, Cedar Knolls, NJ (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 12/364,141

(22) Filed: Feb. 2, 2009

(51) Int. Cl. G08B 21/00

(52) U.S. Cl. 340/540

(57) ABSTRACT

Systems, methods, and computer program products are provided for enhanced business process monitoring. The system may receive input identifying a transaction segment, receive past operational data associated with the transaction segment, generate a unique electronic signature associated with the transaction segment, associate a threshold with the transaction segment, and monitor the current operational data associated with the transaction segment to determine if the threshold has been exceeded.

### BACKGROUND OF THE INVENTION

Business processes have become paramount to the operation, success, and growth of many businesses. For example, business processes can encompass most functional areas of a business, such as order entry, order fulfillment, shipping, billing, payment collection, delivery, and customer service. In essence, these business processes often become the business. Presently, business intelligence systems attempt to provide information regarding the operational health of business processes (and their respective segments) by monitoring the infrastructure associated with the processes. For example, if a server becomes non-operational, current business intelligence systems may be able to indicate that a business process has been disrupted. However, current business intelligence systems are unable to determine: (a) the “actual” operational health of a given process, such as if a strike or severe weather conditions have affected the operation of a business process; (b) if a process is operating in a degraded functional state; and (c) the actual impact to the business or business process in the event of a disruption to a business process. Thus, there exists a need for a comprehensive system to monitor, instrument, and evaluate the actual operational health of business processes in real time or near real time and to determine the impact of business process disruptions.

### BRIEF SUMMARY OF THE INVENTION

In general, embodiments of the present invention provide systems and methods for enhanced business process monitoring and instrumenting. In particular, transaction segments of a business process can be monitored, instrumented, and evaluated in real time or near real time to identify business process disruptions or delays and their impact on the business process.

In accordance with one aspect, a system is provided for enhanced business process monitoring. In one embodiment, the system may comprise one or more memory storage areas and one or more processors coupled to the one or more memory storage areas. In one embodiment, the one or more processors are configured to: electronically receive input identifying a first transaction segment and a second transaction segment of a business process; electronically receive (a) past operational data associated with the first transaction segment and (b) past operational data associated with the second transaction segment; electronically generate (a) a unique electronic signature associated with the first transaction segment based on the past operational data associated with the first transaction segment and (b) a unique electronic signature associated with the second transaction segment based on the past operational data associated with the second transaction segment; electronically associate (a) a first critical threshold with the first transaction segment and (b) a second critical threshold with the second transaction segment; electronically receive (a) current operational data associated with the first transaction segment and (b) current operational data associated with second transaction segment; electronically determine if the current operational data exceeds (a) the first critical threshold associated with the first transaction segment or (b) the second critical threshold associated with the second transaction segment; and in response to a determination that the current operational data exceeds the first critical threshold or the second critical threshold, electronically generate an alert indicating that a critical threshold has been exceeded.

In accordance with another aspect, a computer program product is provided, which contains at least one computer-readable storage medium having computer-readable program code portions stored therein. The computer-readable program code portions of one embodiment may include: a first executable portion configured to receive input identifying a first transaction segment and a second transaction segment of a business process; a second executable portion configured to electronically receive (a) past operational data associated with the first transaction segment and (b) past operational data associated with the second transaction segment; a third executable portion configured to electronically generate (a) a unique electronic signature associated with the first transaction segment based on the past operational data associated with the first transaction segment and (b) a unique electronic signature associated with the second transaction segment based on the past operational data associated with the second transaction segment; a fourth executable portion configured to electronically associate (a) a first critical threshold with the first transaction segment and (b) a second critical threshold with the second transaction segment; a fifth executable portion configured to electronically receive (a) current operational data associated with the first transaction segment and (b) current operational data associated with second transaction segment; a sixth executable portion configured to electronically determine if the current operational data exceeds (a) the first critical threshold associated with the first transaction segment or (b) the second critical threshold associated with the second transaction segment; and a seventh executable portion configured to electronically generate an alert indicating that a critical threshold has been exceeded in response to a determination that the current operational data exceeds the first critical threshold or the second critical threshold.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an overview of one embodiment of a system that can be used to practice aspects of the present invention.

FIG. 2 shows a business command center system according to one embodiment of the invention.

FIGS. 3 and 4 show an exemplary business process capable of use with one embodiment of the present invention.

FIGS. 5-6 are flowcharts illustrating operations and processes that can be used in accordance with various embodiments of the present invention.

FIGS. 7-17 show universal input and output produced by one embodiment of the invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### Methods, Apparatus, Systems, and Computer Program Products

As should be appreciated, the embodiments may be implemented as methods, apparatus, systems, or computer program products. Accordingly, the embodiments may take the form of an entirely hardware embodiment, an entirely software embodiment, or an embodiment combining software and hardware aspects. Furthermore, the various implementations may take the form of a computer program product on a computer-readable storage medium having computer-readable program instructions (e.g., computer software) embodied in the storage medium. More particularly, implementations of the embodiments may take the form of web-implemented computer software. Any suitable computer-readable storage medium may be utilized including hard disks, CD-ROMs, optical storage devices, or magnetic storage devices.

The embodiments are described below with reference to block diagrams and flowchart illustrations of methods, apparatus, systems, and computer program products. It should be understood that each block of the block diagrams and flowchart illustrations, respectively, can be implemented by computer program instructions, e.g., as logical steps or operations. These computer program instructions may be loaded onto a general purpose computer, special purpose computer, or other programmable data processing apparatus to produce a machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### General Overview

In general, according to various embodiments of the present invention, methods, apparatus, systems, and computer program products are provided for enhanced business process monitoring, such as via a business command center system. In one embodiment, the process begins by identifying transaction segments of a business process, such as order request; order entry; order processing; order routing; order dispatch; and order completion and confirmation. After the transaction segments have been identified, the underlying infrastructure (e.g., applications, system components, and networks) of the transaction segments is evaluated to determine how the data of the business process flows through the carrier's infrastructure. That is, the business process is evaluated to determine how, in this example, orders progress through each transaction segment. By identifying the transaction segments and their associated infrastructure and process flows, analysts can have a better understanding of how the business process flows. The analysts can then use this information to evaluate the business process at different layers of abstraction, e.g., business metrics, infrastructure/applications, data feeds, and networks. With this collection of information, business metrics for determining the health of each transaction segment and the overall business process are identified. Similarly, the infrastructure is evaluated to determine how to receive information regarding the appropriate business metrics.

After identifying the relevant business metrics for each transaction segment, the next step is to receive the data representative of the business metrics from past operations that span, for example, six months, three months, one month, a week, or a day. With the past operational data, the business commander center system can generate one or more unique electronic signatures for each transaction segment. In one embodiment, the business command center system then receives user input to associate various thresholds with the respective transaction segments, such as predictive thresholds, degradation thresholds, and critical thresholds.

After the electronic signatures have been generated and the thresholds have been identified, the business command center system receives current operational data regarding the transaction segments. The business command center system then monitors the current operational data for statistical deviations from the electronic signatures, such as a percentage deviation from the electronic signature, a number deviation from the electronic signature, or a time and percentage/number deviation from an electronic signature or other statistical deviations. If the deviations exceed one or more of the thresholds, the business command center system generates an alert and evaluates the impact of the business disruption or delay to the transaction segment or the business process.

### Exemplary System Architecture

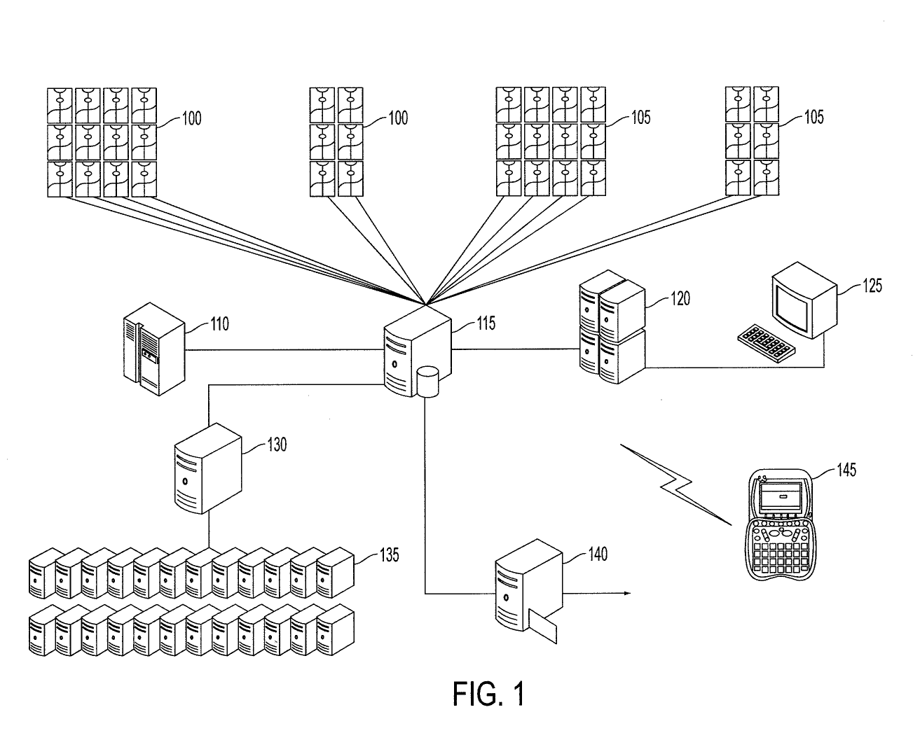

FIG. 1 provides an illustration of one type of system that can be used in conjunction with various embodiments of the present invention. As shown in FIG. 1, the system may include: (1) a business command center system 125; (2) one or more web order application servers 100; (3) one or more phone order systems 105; (4) a mainframe 110; (5) a business command center database 115; (6) a web application server 120; (7) a central order dispatch server 130; (8) one or more local order dispatch servers 135; (9) an alert server 140; and (10) a handheld electronic device 145. In general, the terms “system,” “mainframe,” and “server” are used generically (and interchangeably) throughout to refer to any computer, computing device, desktop, notebook or laptop, distributed system, server, gateway, switch, or other processing device configured to perform the functions described herein. The term “or” is used herein in both the alternative and conjunctive sense, unless otherwise indicated. The term “database” refers to a structured collection of records or data that is stored in a computer system, such as via a relational database, hierarchical database, or network database. Each of these components of the system may be in electronic communication with, for example, one another, a shipper (e.g., a carrier), a consignee, or a consignor (e.g., with the aid of a personal computer (“PC”), laptop, or similar electronic device) over the same or different wireless or wired networks including, for example, a wired or wireless Personal Area Network (“PAN”), Local Area Network (“LAN”), Metropolitan Area Network (“MAN”), Wide Area Network (“WAN”), or the like. Additionally, while FIG. 1 illustrates the various system entities as separate, standalone entities, the various embodiments are not limited to this particular architecture. For example, the functionality of the (1) business command center system 125; (2) one or more web order application servers 100; (3) one or more phone order systems 105; (4) mainframe 110; (5) business command center database 115; (6) web application server 120; (7) central order dispatch server 130; (8) one or more local order dispatch servers 135; and (9) alert server 140 may each occur on a single server, a mainframe computer system, multiple distributed or centralized servers, or similar computer systems or network entities.

a. Exemplary Business Command Center System

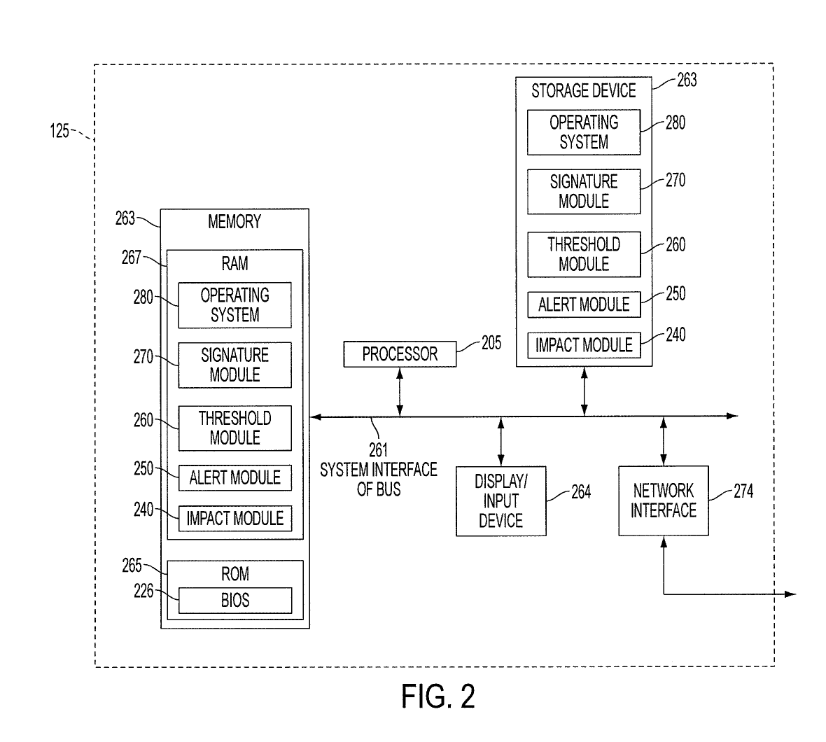

FIG. 2 provides a schematic of a business command center system 125 according to one embodiment of the present invention. As will be understood from this figure, in this embodiment, the business command center system 125 includes a processor 205 that communicates with other elements within the business command center system 125 via a system interface or bus 261. The processor 205 may be embodied in a number of different ways. For example, the processor 205 may be embodied as various processing means such as a processing element, a coprocessor, a controller or various other processing devices including integrated circuits such as, for example, an application specific integrated circuit (“ASIC”), a field programmable gate array (“FPGA”), a hardware accelerator, or the like. In an exemplary embodiment, the processor 205 may be configured to execute instructions stored in the device memory 263 or otherwise accessible to the processor 205. As such, whether configured by hardware or software methods, or by a combination thereof, the processor 205 may represent an entity capable of performing operations according to embodiments of the present invention while configured accordingly. A display device/input device 264 for receiving and displaying data is also included in the business command center system 125. This display device/input device 264 may be, for example, a keyboard or pointing device that is used in combination with a monitor. The business command center system 125 further includes memory 263, which may include both read only memory (“ROM”) 265 and random access memory (“RAM”) 267. The business command center system's ROM 265 may be used to store a basic input/output system (“BIOS”) 226 containing the basic routines that help to transfer information to the different elements within the business command center system 125.

In addition, in one embodiment, the business command center system 125 includes at least one storage device 263, such as a hard disk drive, a CD drive, and/or optical disk drive, for storing information on various computer-readable media. The storage device(s) 263 and its associated computer-readable media may provide nonvolatile storage. The computer-readable media described above could be replaced by any other type of computer-readable media, such as embedded or removable multimedia memory cards (“MMCs”), secure digital (“SD”) memory cards, Memory Sticks, electrically erasable programmable read-only memory (“EEPROM”), flash memory, hard disk, or the like. Additionally, each of these storage devices 263 may be connected to the system bus 261 by an appropriate interface.

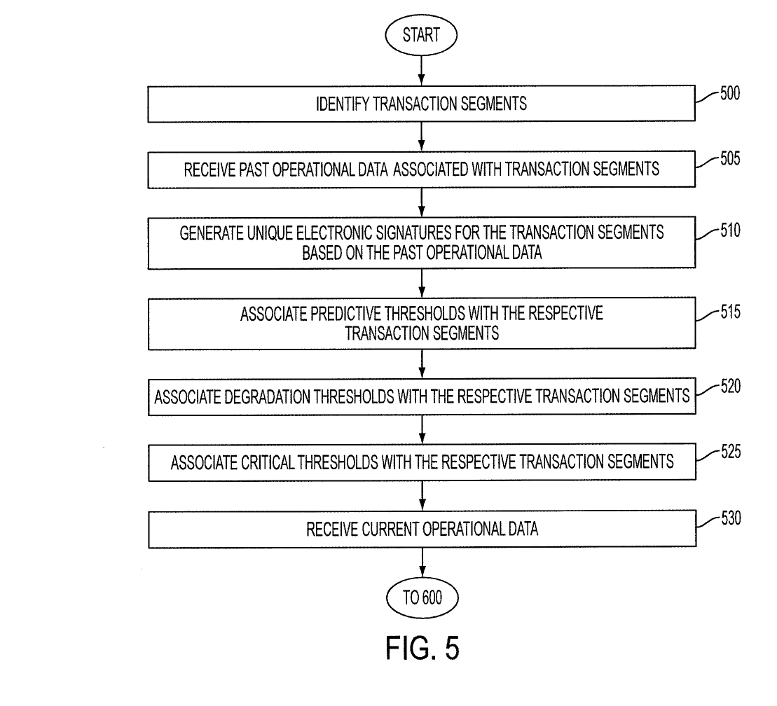

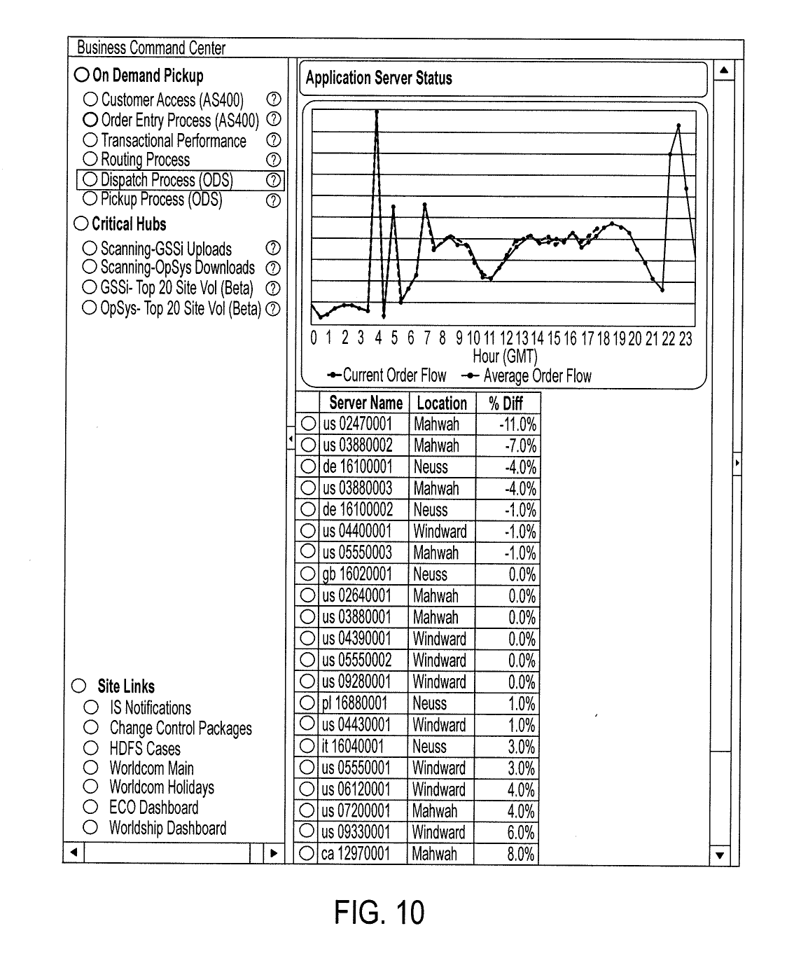

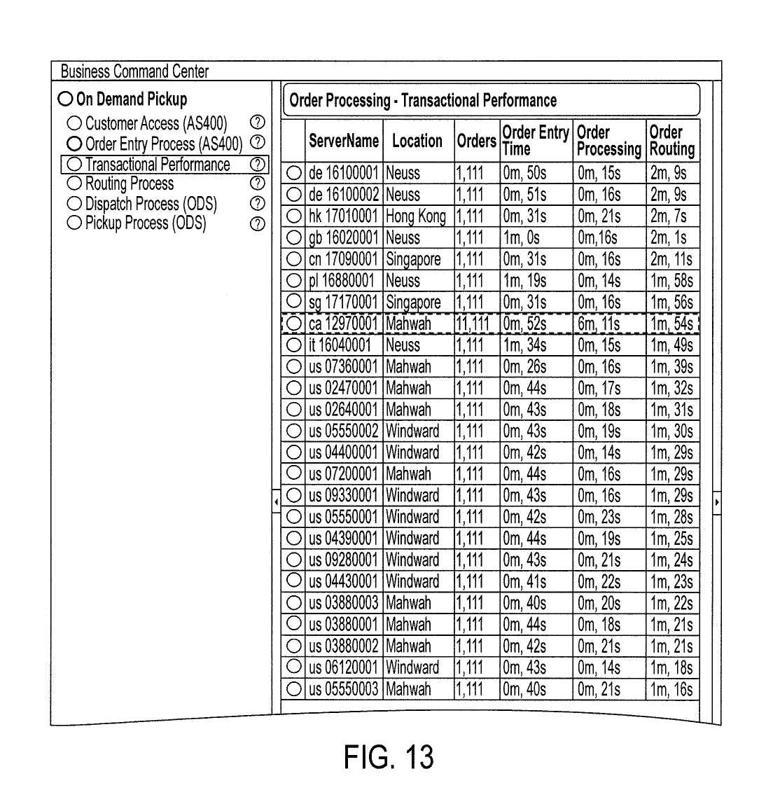

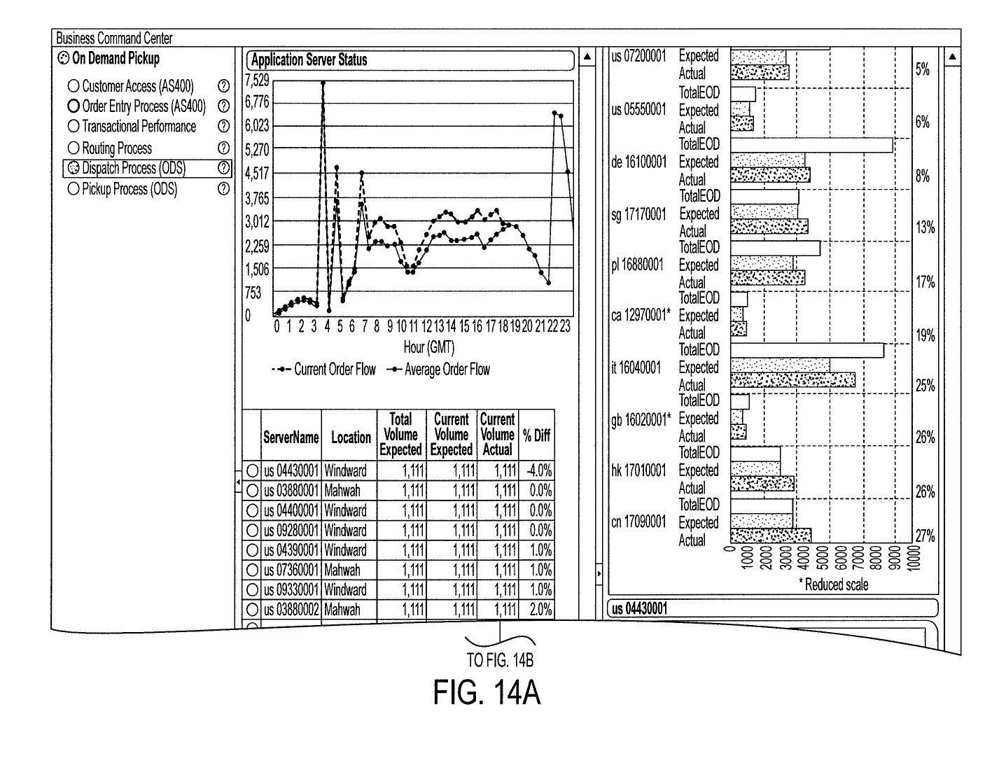

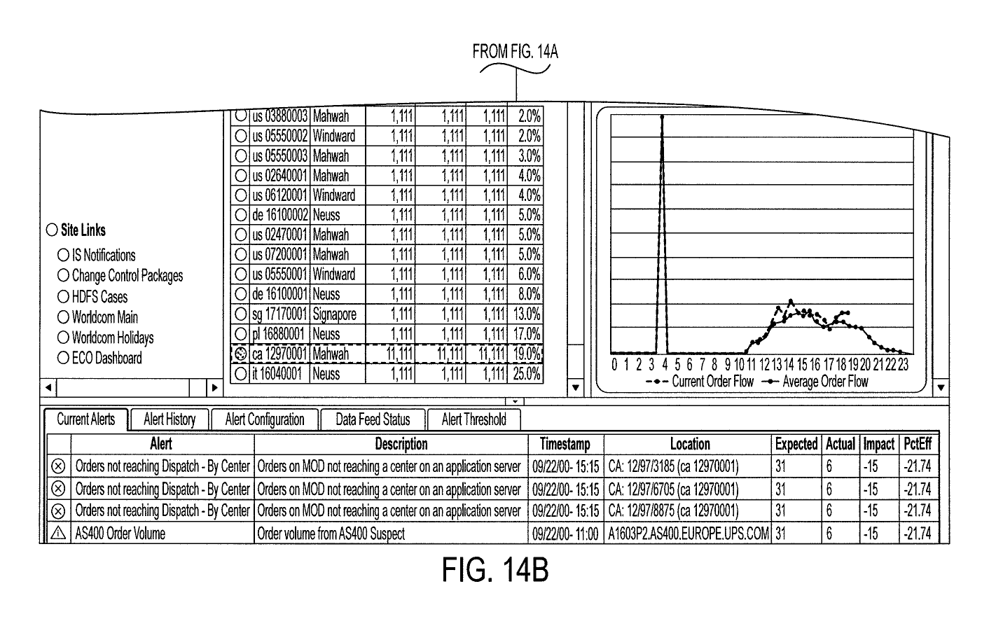

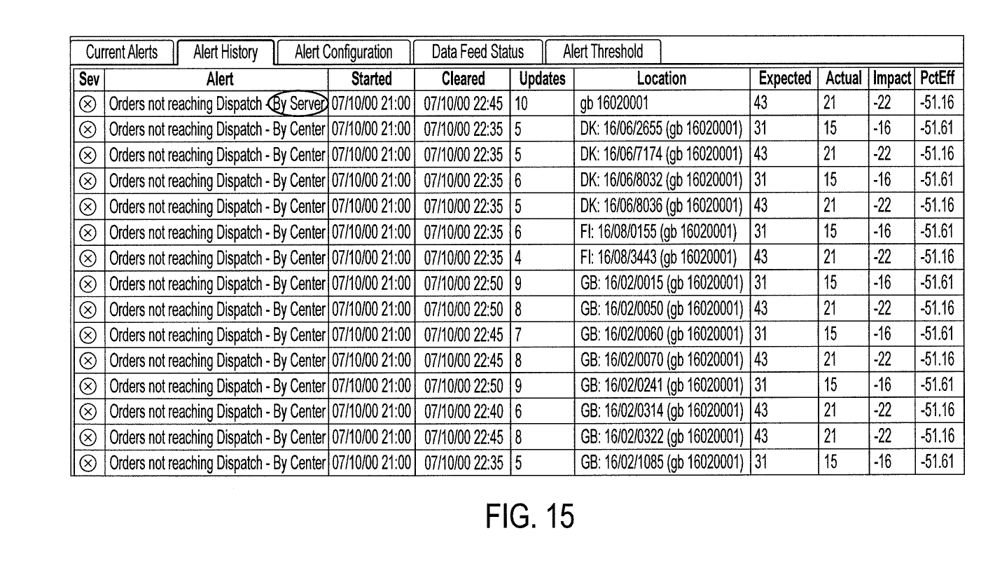

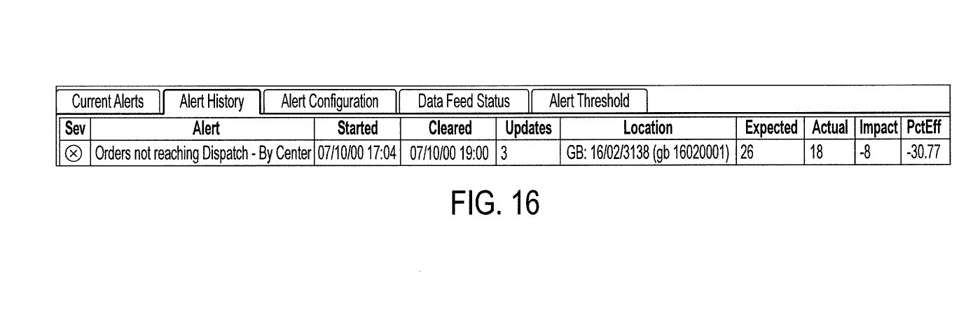

Furthermore, a number of program modules may be stored by the various storage devices 263 and/or within RAM 267. Such program modules may include an operating system 280, a signature module 270, a threshold module 260, an alert module 250, and an impact module 240. These modules may control certain aspects of the operation of the business command center system 125 with the assistance of the processor 205 and operating system 280. For example, as discussed in more detail below with regard to FIGS. 5-17, according to one embodiment, the signature module 270 generates electronic signatures from past operational data, representative of the business process. Additionally, the threshold module 260 determines if current operational data deviates from the electronic signature. If the current operational data deviates from the electronic signature, the alert module 250 generates an alert and the impact module 240 determines the impact of the deviation to the business process. In addition to the program modules, the business command center system 125 may store or be connected to one or more databases (e.g., business command center database 115) with one or more tables stored therein. The described architectures are provided for illustrative purposes only and are not limiting to the various embodiments. In this regard, although various program modules are described, the software need not be modularized.

Also located within the business command center system 125, in one embodiment, is a network interface 274 for interfacing with the (1) one or more web order application servers 100; (2) one or more phone order systems 105; (3) mainframe 110; (4) business command center database 115; (5) web application server 120; (6) central order dispatch server 130; (7) one or more local order dispatch servers 135; (8) alert server 140; and (9) handheld electronic device 145. This communication may be via the same or different wired or wireless networks (or a combination of wired and wireless networks), as discussed above. For instance, the communication may be executed using a wired data transmission protocol, such as fiber distributed data interface (“FDDI”), digital subscriber line (“DSL”), Ethernet, asynchronous transfer mode (“ATM”), frame relay, data over cable service interface specification (“DOCSIS”), or any other wired transmission protocol. Similarly, the business command center system 125 may be configured to communicate via wireless external communication networks using any of a variety of protocols, such as 802.11, general packet radio service (“GPRS”), wideband code division multiple access (“W-CDMA”), or any other wireless protocol.

b. Additional Exemplary System Components

Although not shown, the (1) one or more web order application servers 100; (2) one or more phone order systems 105; (3) mainframe 110; (4) business command center database 115; (5) web application server 120; (6) central order dispatch server 130; (7) one or more local order dispatch servers 135; (8) alert server 140; and (9) handheld electronic device 145 may each include components and functionality similar to that of the business command center system 125. For example, in one embodiment, each of the entities includes: (1) a processor that communicates with other elements via a system interface or bus; (2) a display device/input device; (3) memory including both ROM and RAM; (4) a storage device; and (5) a network interface. These architectures are provided for exemplary purposes only and are not limiting to the various embodiments.

### Exemplary System Operation

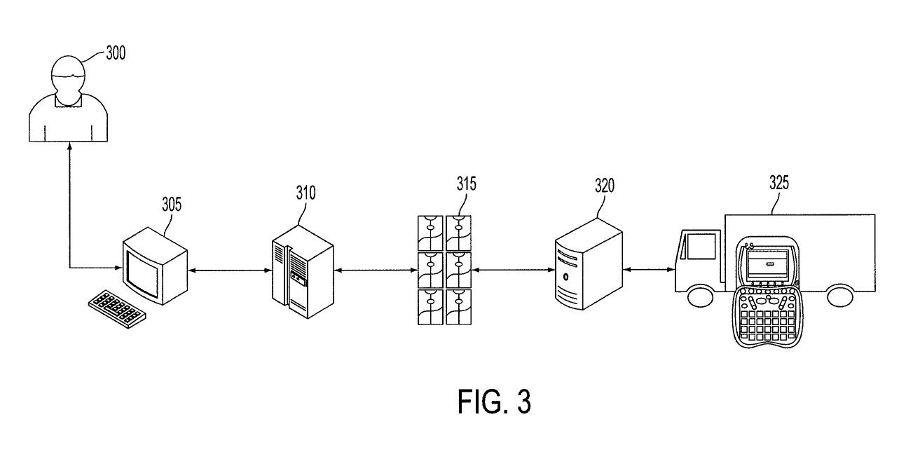

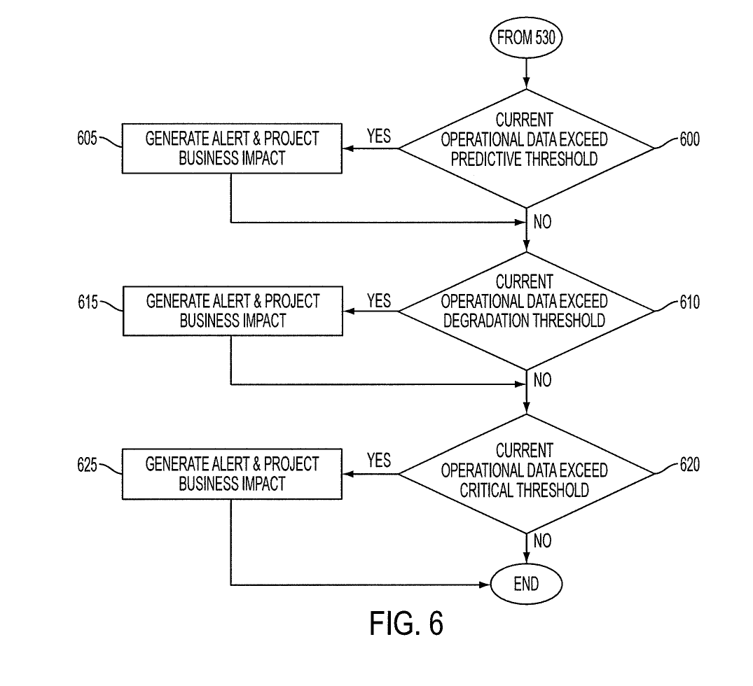

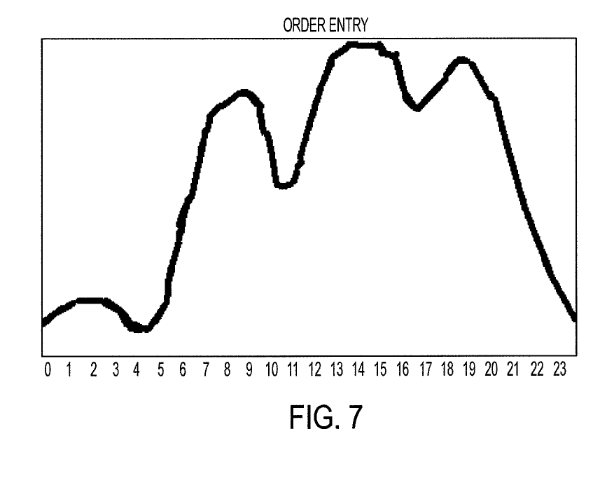

Reference will now be made to FIGS. 3-19, which provide (a) an exemplary business process and business process segments, (b) exemplary operations, and (c) exemplary input and output produced by various embodiments of the present invention. In particular, FIGS. 5-6 provide flowcharts illustrating operations that may be performed to provide enhanced business process monitoring. Some of these operations will be described in conjunction with FIGS. 7-17, which illustrate input and output that may be produced by carrying out the selected operations described in relation to FIGS. 5-6.

a. Identify Transaction Segments of Business Process

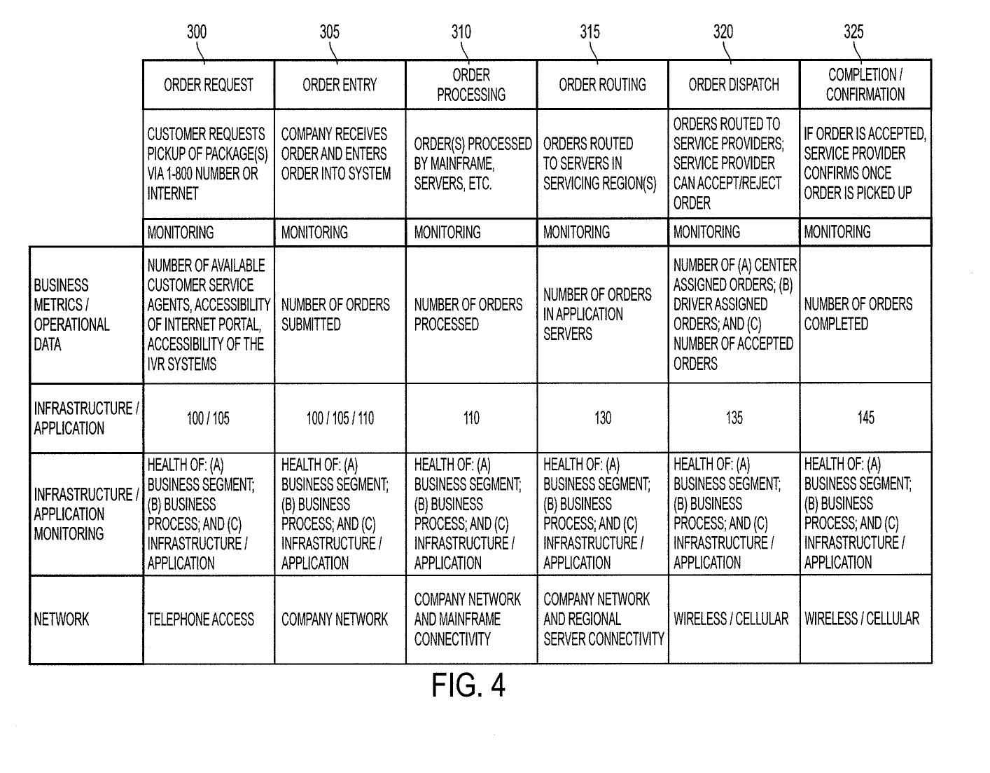

In one embodiment, the process begins by identifying transaction segments of a business process, such as by receiving input from a user identifying particular transaction segments (Block 500). The term “transaction segment” generally refers to a step or stage in a business process. For example, as shown in FIGS. 3 and 4, an exemplary business process may comprise six transaction segments: order request 300; order entry 305; order processing 310; order routing 315; order dispatch 320; and order completion and confirmation 325. In this particular business process, the term “order” refers to picking up a package from a consignor (or other party) for shipment. Thus, an order request 300 by a customer generally refers to receiving a request via, for example, a carrier's website or interactive voice response (“IVR”) system to pick up a package for shipment. In this embodiment, after the order is received, the order is entered into the carrier's system (305) and processed (310). After being entered and processed by the system, the orders are routed to servers that service the regions in which the orders are to be picked up (315). For example, the order may be routed to a facility in Atlanta, Ga. that services the location from where the package is to be picked up. At this point, the orders are then dispatched (e.g., transmitted) to specific service providers (e.g., delivery drivers) to pick up the orders (320). In one embodiment, the service providers can accept or reject the orders depending on their schedule. For example, if a service provider is unable to meet a desired pick-up time, she may reject the order so that it can be dispatched to another service provider for pick up. If the service provider accepts the order, she then completes the order (e.g., picks up the package for shipment) and provides a completion confirmation once the order has been completed (Block 325).

The above transaction segments are described in relation to an illustrative business process that can be used with embodiments of the present invention. There are, though, many other business processes that can also be used in conjunction with the embodiments of the present invention. For example, monitoring (a) data movement operations, (b) scan volume of packages being transported through a carrier's transportation network, and (c) freight pick-up are exemplary business processes that can be used with embodiments of the present invention.

b. Identify Infrastructure Underlying Transaction Segments of Business Process

In one embodiment, after the transaction segments have been identified, the underlying infrastructure (e.g., applications, system components, and networks) of the transaction segments is evaluated to determine how the data of the business process flows through the carrier's infrastructure. That is, the business process is evaluated to determine how, in this example, orders progress through each transaction segment. This may involve identifying team and project resources, technological infrastructure components (e.g., servers, mainframes, etc.) and their related applications, and business locations. The following describes the underlying infrastructure of the above-discussed exemplary business process.

Continuing with the above example, the order request is received from a customer through the carrier's website (e.g., via a web order application server 100) or through an automated calling system such as an IVR (e.g., via a phone order system 105). Thus, a customer, for example, can access the carrier's website to request that a package be picked up from the customer. Similarly, the customer may call into the carrier's IVR system and navigate through voice prompts or speak to an agent to initiate an order request. After the order request is received, the order is entered into (e.g., automatically or with the aid of human interaction) and processed by the carrier's computer system. In one embodiment, the entering can occur via a system such as an IBM AS400 and the processing steps occur via the mainframe 110. After being entered and processed, the orders are routed to servers that service the regions in which the orders are to be picked up. In one embodiment, this is performed by transmitting the orders to a central order dispatch server 130 that services a particular region such as the southeastern United States. The central order dispatch server 130 then routes each order to the appropriate local order dispatch servers 135. In one embodiment, the local order dispatch servers 135 service a particular area within the region, such as Atlanta, Ga. In turn, the orders are routed from the local dispatch servers 135 to the handheld electronic devices 145 of the appropriate individual service providers (e.g., delivery drivers). For example, the orders can be sent to the handheld electronic devices 145 of the service providers servicing the respective pick-up locations. Using the handheld electronic devices 145, the individual service providers can accept or reject the received order(s). If the service provider accepts the order, she then completes the order (e.g., picks up the package for shipment from the pick-up location) and provides a completion confirmation via the handheld electronic device 145 that the order has been completed. Similarly, the service providers can reject the orders via the handheld electronic devices 145 so that the orders can be routed to other service providers.

The above describes an exemplary business process, transaction segments, and their associated infrastructure and process flows. By identifying this information, analysts can have a better understanding of how the business process flows. The analysts can then use this information to evaluate the business process at different layers of abstraction, such as those shown in FIG. 4 (e.g., business metrics, infrastructure/applications, data feeds, and networks). The collection of this information defines the business process in business terms, e.g., in terms of what is important to the flow and health of the business process.

c. Identify Business Metrics Associated with Transaction Segments of Business Process

In one embodiment, using the above-discussed collection of information, business metrics for determining the health of each transaction segment and the overall business process are identified. Moreover, after identifying the pertinent business metrics for each transaction segment, the infrastructure, for example, is evaluated to determine how to receive information regarding the appropriate business metrics. In the exemplary business process, as shown in FIG. 4, each transaction segment is associated with one or more business metrics that are received from one or more system components (or determined by some other means). The business metrics may be identified by determining the total number of orders, for example, progressing through a transaction segment. In this example, this information may be derived in a variety of ways. For example, in one embodiment, a data structure associated with each order can be evaluated by the business command center system 125 to determine if the order has progressed from one transaction segment to another. For example, the data structure may have a status field that can be changed to indicate the current transaction segment of the order. In another example, the number of orders completed as received by the handheld electronic devices 145 can be monitored or instrumented to determine the total number of orders completed during a given time period or by querying the business command center database 115. Thus, the operational health of a transaction segment can be determined by information other than the operational state or availability of a server or other infrastructure component.

Continuing with the above example, FIG. 4 provides the business metrics (i.e., operational data) for each transaction segment of the business process, which provides an indication of the operational health of the transaction segments (a portion of FIG. 4 is reproduced in Table 1 below). FIG. 4 also identifies the infrastructure or applications used to evaluate the operational health of each transaction segment.

TABLE 1

| | Order Request | Order Entry | Order Processing | Order Routing | Order Dispatch | Compl./Conf. |
|---|---|---|---|---|---|---|
| | Monitoring | Monitoring | Monitoring | Monitoring | Monitoring | Monitoring |
| Business Metrics/ | Number of available | Number of orders | Number of orders | Number of orders | Number of (a) | Number of |
| Operational Data | customer service | submitted | processed | in application | center assigned | completed orders |
| | agents, accessibility | | | servers | orders; (b) driver | |
| | of Internet portal, | | | | assigned orders; | |
| | and the accessibility | | | | and (c) number of | |
| | of the IVR systems | | | | accepted orders | |
| Infrastructure/ | 100/105 | 100/105/110 | 110 | 130 | 135 | 145 |
| Application | | | | | | |

For instance, the operational health of the order request transaction segment 300 can be evaluated based on the number of available customer service agents, the accessibility of the Internet portal, and/or the accessibility of the IVR systems. The data representative of these and other business metrics can be evaluated or received from various entities, such as the web order application server 100 and the phone order system 105. Similarly, the operational health of the order completion and confirmation transaction segment 325 can be evaluated based on the number of orders completed during a given time period. The number of orders completed may be determined from the number of completion confirmation messages received from the various handheld electronic devices 145 or based on the number of orders that had their status changed to “completed” as determined by the mainframe 110 or via the business command center database 115.

d. Receive Business Metrics and Generate Unique Electronic Signatures

In one embodiment, after identifying the relevant business metrics for each transaction segment, the next step is to receive the data representative of the business metrics (Block 505). In one embodiment, the data for each transaction segment is received from past operations that span, for example, six months, three months, one month, a week, or a day. This “past operational data” provides information with regard to the details of the respective transaction segments. In one embodiment, the past operational data includes data that details how the transactions segments operated during the previous six months (see FIG. 4). Thus, continuing with the above example, the past operational data includes: (1) the number of available customer service agents, accessibility of the Internet portal (e.g., the one or more web order application servers 100), and accessibility of the IVR systems (the one or more phone order systems 105); (2) the number of orders submitted; (3) the number of orders processed; (4) the number of orders routed through the central order dispatch server 130; (5) the number of (a) center assigned orders, (b) driver assigned orders, and (c) accepted orders; and (6) the number of completed orders. With this information, for instance, the business command center system 125 can determine how many orders were submitted over the past six months, three months, month, week, day, and any other time during the period (e.g., from 5:00 pm to 6:00 pm on Nov. 24, 2004).

Thus, after receiving the past operational data, the business commander center system 125 generates one or more unique electronic signatures for each transaction segment (generated via a signature module 270). The term “electronic signature” refers to a model of the business metrics generated from the past operational data-such as an electronic signature of a transaction segment, a particular location of a transaction segment, or a business process over a specific period of time. An example of a unique electronic signature is shown in FIG. 7 (volume details not shown). This exemplary electronic signature shows the order volume (y-axis) over a 24 hour period (x-axis). As indicated, there may be multiple unique electronic signatures generated by the business command center system 125 for each transaction segment. For example, in one embodiment, an electronic signature is generated (e.g., “learned”) based on the specific nature of a given business process. In one embodiment, electronic signatures are generated using an adjusted weighted moving average for each weekday based on an appropriate timeframe for the business process (e.g., on a three-month or six-month average.) Similarly, an electronic signature can be generated for each first Monday of the month based on the six-month average. The time period of each electronic signature may vary based on the detail needed to monitor the given transaction segment. Thus, each business process has its own unique profile (e.g., electronic signature) based on its data flow measured in real business terms of that business process. In one particular embodiment, this creates the ability to measure the health of the overall business process.

In another embodiment, the business commander center system 125 generates one or more electronic signatures for the various locations used in the respective transaction segments (Block 510). For instance, the business command center system 125 may generate electronic signatures for each weekday for each location (or regional server) associated with a particular transaction segment, such as Utah, Spain, Germany. This provides the ability to monitor location-specific information regarding the operational health of a transaction segment. Thus, providing electronic signatures for each location, for example, may allow a user to drill down to find out where delays or disruptions to the transaction segment are occurring.

e. Associate Thresholds with Transaction Segments

In one embodiment, as described, the electronic signatures provide information with regard to how the various transaction segments have performed in the past-based on the identified business metrics. With this information, the business command center system 125 can receive user input to associate various thresholds with the respective transaction segments (Blocks 515, 520, and 525). In one embodiment, the thresholds include predictive thresholds, degradation thresholds, and critical thresholds (associated with the electronic signatures via a threshold module 260).

Generally, “predictive thresholds” identify when the current flow of a transaction segment indicates that a disruption to the transaction segment is likely or probable. This type of predictive threshold allows for proactive measures to be taken before the impending disruption significantly impacts the transaction segment or the business process. For example, in one embodiment, a predictive threshold might be used to track the statistically significant deviation (e.g., reduction) of a transaction segment from one or more electronic signatures, such as a 2% decrease in a transaction segment's volume each hour over a five hour period.

In general, “degradation thresholds” are used to identify when the current flow of a transaction segment indicates that the transaction segment is experiencing a disruption or delay that is not significantly impacting the transaction segment or the business process, but that will not allow the transaction segment to function at maximum capacity allowing the business command center to accurately measure slowdowns, measure degraded service, or predict an upcoming failure.

And finally, “critical thresholds” are used to identify when the current flow of a transaction segment indicates that the transaction segment is experiencing a disruption or delay that has significantly impacted or is significantly impacting the transaction segment or the business process. For example, if no order completion confirmations are received over a three hour period, such a deviation from the electronic signature may significantly impact the transaction segment. Another exemplary threshold could be the number of orders not accepted within 90 minutes of the commitment time.

These types of thresholds may be used, for example, to monitor the current operational data deviations from the electronic signatures, such as a percentage deviation from the electronic signature, a number deviation from the electronic signature, or a time and percentage/number deviation from an electronic signature. Continuing with the above example, in the order completion/confirmation transaction segment 325, the critical threshold may be set at 20%. In this example, if a particular location typically receives 1,000 order completion confirmations from the various electronic handheld devices 145 on average in a 24 hour period, a 20% reduction would indicate that at least 200 fewer order completion confirmations were received than expected. However, if a particular location only receives ten order completion confirmations on average in a 24 hour period, the critical threshold may be set to identify deviations of five or fewer total order completion confirmations during a specific time period.

As discussed above, the thresholds can be used to monitor disruptions or delays to the various transaction segments. However, the thresholds can also be used to track surges that may impact a particular transaction segment. For example, in the order dispatch 320 transaction segment, if a location receives ten order completion confirmations on average in a 24 hour period, and the location receives twenty requests in a three hour period, the location may not have the personnel or capacity to complete the orders, which can be identified by the thresholds. Thus, the thresholds can be driven from the business or infrastructure aspects of the business process. That is, the thresholds can be used to evaluate how the business process is operating, and not just evaluate the availability of the infrastructure.

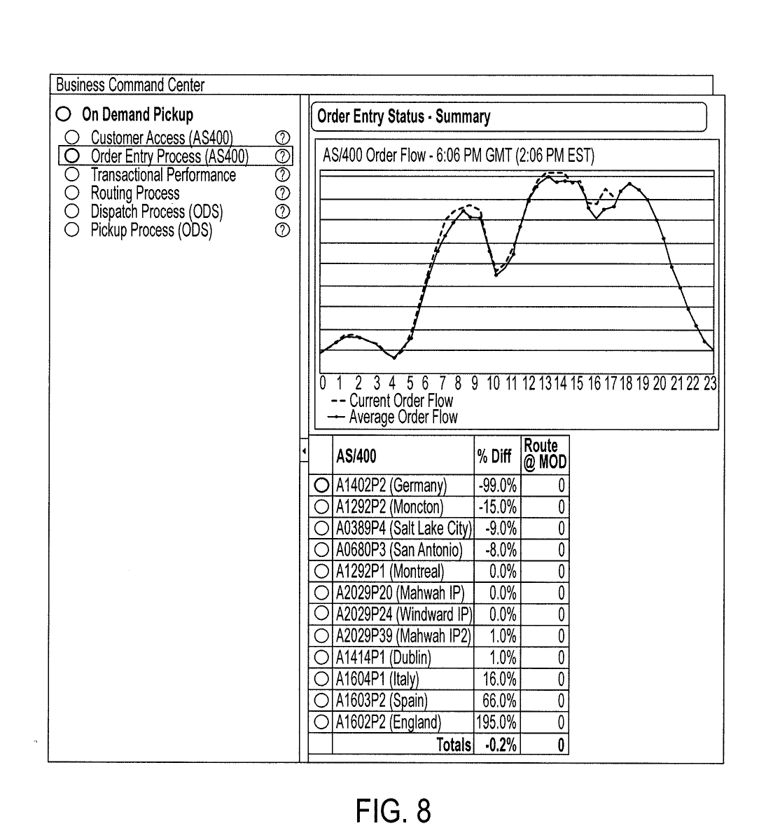

The electronic signatures and the tracking of the current operational data may be displayed via graphs or other visual aids, such as those shown in the graphs of FIGS. 8-11. By displaying the electronic signatures and the current operational data, the user can better understand the transaction segments, volume information, peak times, and information flows that affect the operational health of the transaction segments.

f. Monitor and Instrument Transaction Segments and Business Process

In one embodiment, after the various thresholds have been set by the user and associated with the appropriate electronic signatures (or portions thereof) by the business command center system 125, the business process and the transaction segments can be effectively monitored and instrumented (and displayed as shown in FIGS. 8-17). Exemplary input and output of the monitoring and instrumenting processes are shown in FIGS. 8-17. In monitoring and instrumenting the transaction segments, the business command center 125 receives current operational data regarding each of the transaction segments (Block 530). Thus, in contrast to past operational data, “current operational data” provides information with regard to the current (real time or near real time) details of the respective transaction segments. The current operational data can be received at various intervals throughout the day. To receive this information, the business command center 125 may poll the appropriate infrastructure components or the infrastructure components may be configured to send the necessary information to the business command center system 125 at specific intervals. For example, for each transaction segment, the current operational data my be transmitted from the appropriate infrastructure components in real time or near real time such as every second, every minute, every ten minutes, or every fifteen minutes.

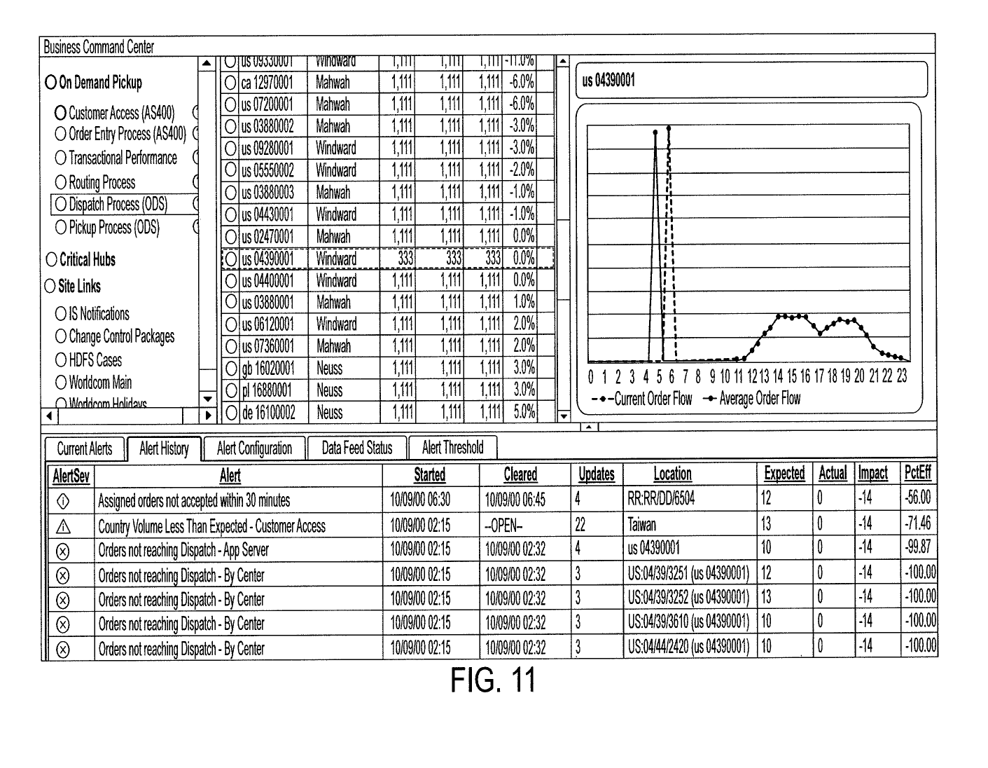

Upon receiving the current operational data, the business command center system 125 then evaluates the current operational data, the electronic signature, and the thresholds to determine if any of the thresholds have been exceeded (Blocks 600, 610, 620). For example, the business command center system 125 may receive current operational data that the mainframe 110 servicing Germany has entered 65% fewer orders than expected based on the electronic signature. In this example, if the one or more of the thresholds were set to any percentage below 65%, the business command center would notify the alert server 140 to generate an alert (Blocks 605, 615, 625). The term “alert” is used generically to indicate some form of notification that a threshold has been exceeded. Alerts may be generated in a variety of ways, including via an alert module 250. In this embodiment, the business command center system 125 may display the alert via a red icon on a display (as shown in FIGS. 11 and 13-16) or the alert server 140 may send a electronic notification to a computer program interface, an incident or problem management program, or a technician's cell phone or other mobile device.

In addition to providing the ability to monitor the operational health of the transaction segments, the business command center system 125 also provides the ability to track an order during its entire lifecycle through the business process, for example. In other words, the business command center system 125 can track an order from the time is received until the time it is completed and evaluate its progress therein. This functionality provides end-to-end visibility of each order as it progresses through the business process. Similarly, with the current operational data, the business command center system 125 can also provide for end-to-end synthetic visibility. That is, the current operational data provides the business command center system 125 with the information necessary to simulate and order progressing through the business process to identify trends and other causes for concern.

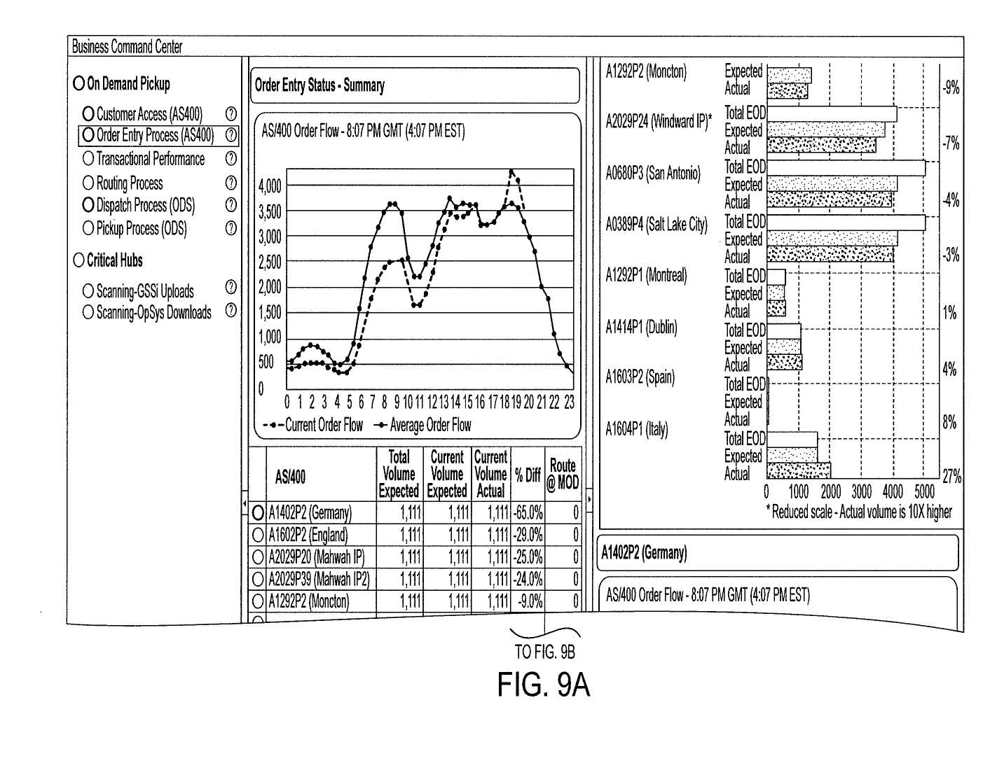

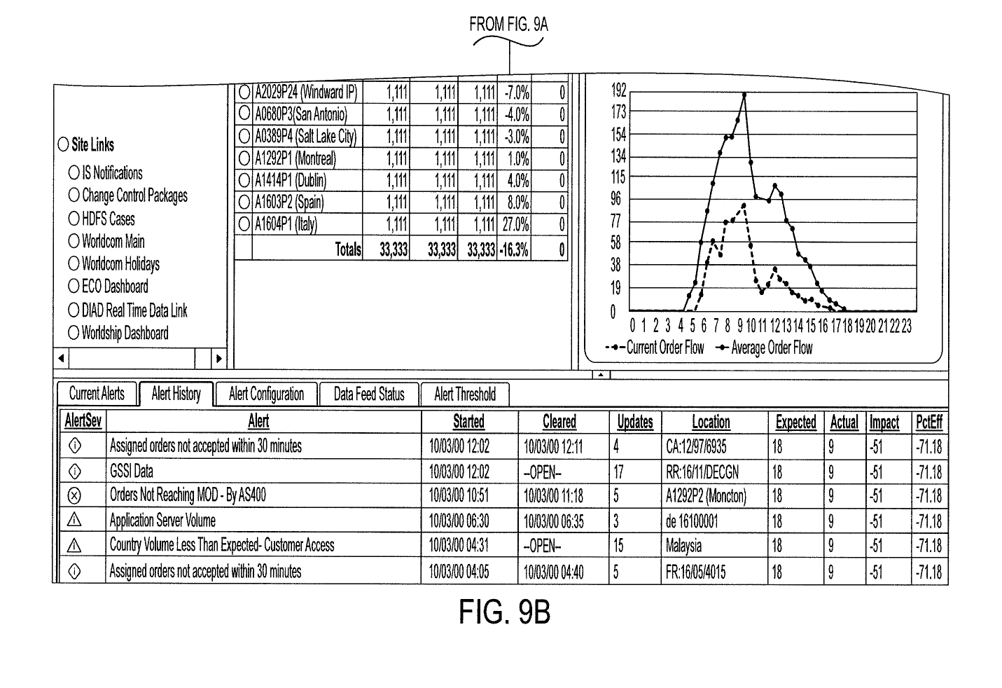

In addition to generating an alert if a particular threshold is exceeded, the business command center system 125 can provide detailed information via the display regarding the alerts. For example, as shown in FIGS. 9, 11, and 14-16, the business command center system 125 can display the current alerts, the alert history (e.g., the alerts that have been generated), the alert configurations (e.g., the type of alert that is generated, such as a text message), and the alert thresholds (e.g., the various thresholds associated with the alerts).

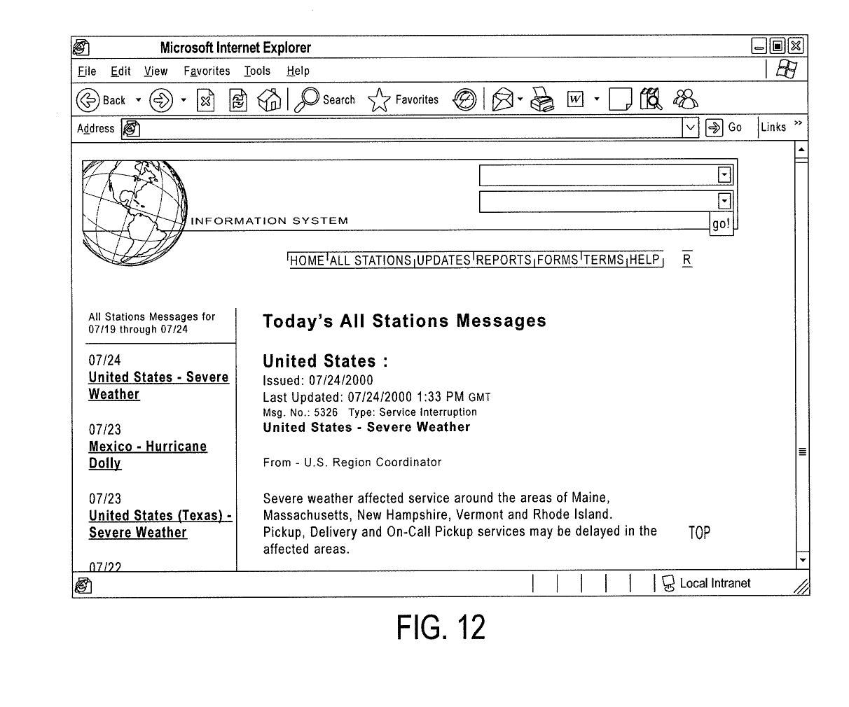

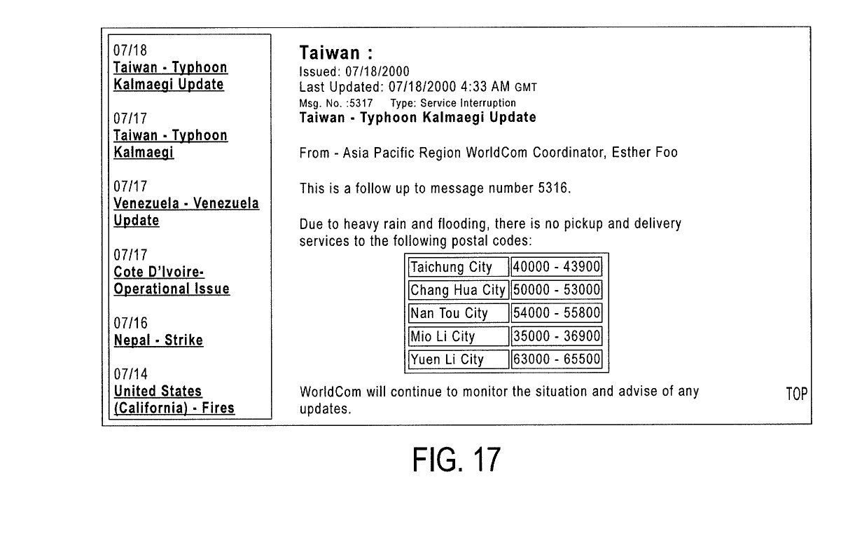

This business command center system 125 also provides the user with ability to view detailed information regarding each of the transaction segments. For example, as shown in FIGS. 9, 11-12, 14, and 17, the user can drill-down to find out more detailed information regarding each transaction segment. In one embodiment, the user can also access additional information that may indicate conditions that are impacting a transaction segment and be able to correlate the impact. For instance, as shown in FIGS. 12 and 17, the business command center system 125 is made aware of weather conditions that may impact the operation of a transaction segment, such as a flood prohibiting pickups at certain postal codes. Other examples of additional information, shown in FIG. 17, include a strike in Nepal, forest fires in California, and a typhoon in Taiwan. Thus, the user is provided with general information, such as the operational data for the order completion confirmation segment 325 (e.g., indicating that segment has generated 40% fewer confirmations than expected), and provides the user with the ability to drill down to find out additional information regarding the particular locations that have generated alerts and potential causes affecting the transaction segment. For example, the user can continue to drill down and find out that weather conditions, strikes, or other causes are affecting the transaction segment. With this information, the user is in a much better to position to remedy or limit disruptions to the transaction segments and to the business process.

g. Determine Impact of Disruptions/Delays to Business Process

In one embodiment, based on the electronic signatures and the current operational data, the business command center system 125 can determine the actual impact of a business disruption, whether the disruption is from an information technology, an operational, a procedural, or an external environmental factor. For example, in one embodiment, the actual impact to the business process can be determined in a variety of ways. For example, it can be determined by evaluating orders that have progressed through the other transaction segments in the business process. Additionally or alternatively, the business impact can be determined with the aid of the electronic signature. For example, if a particular server is expected to dispatch 4,200 orders an hour and alert is generated at 10:03 am and is cleared at 11:59 am, the business command center system 125 (via the impact module 240) can determine how far behind the transaction segment is behind based on the past operational data or the current operational data, or both. Similarly, the business command center system 125 can evaluate how many orders have been entered during the time frame (e.g., using operational data from another transaction segment), but not dispatched. The business command center system 125 monitoring and instrumenting enables detection of non-traditional disruptions as well, such as poor business logic. For example, since the business command center system 125 monitors the overall business process, events like poor business logic are identifiable.

In another example, if 385 orders missed their assigned pick-up commit times because of traffic delays, the business command center system 125 can evaluate the impact by tracking: (a) the orders not picked up by their commit times, (b) the number of orders missed during that time, and (c) the number of orders not picked up at all. The business command center system 125 can therefore keep track of the true business impact of an outage or event in real business terms. For example, if a transit strike in Spain is impacting the ability of local delivery centers to service orders, the impact can be measured in orders not only for that day but the subsequent days as well.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for monitoring the operational health of a business process, the system comprising one or more memory storage areas and one or more processors coupled to the one or more memory storage areas, the one or more processors configured to:
electronically receive input identifying a first transaction segment and a second transaction segment of a business process;
electronically receive (a) past operational data associated with the first transaction segment and (b) past operational data associated with the second transaction segment;
electronically generate (a) a unique electronic signature associated with the first transaction segment based on the past operational data associated with the first transaction segment and (b) a unique electronic signature associated with the second transaction segment based on the past operational data associated with the second transaction segment;
electronically associate (a) a first critical threshold with the first transaction segment and (b) a second critical threshold with the second transaction segment;
electronically receive (a) current operational data associated with the first transaction segment and (b) current operational data associated with second transaction segment;
electronically determine if the current operational data exceeds (a) the first critical threshold associated with the first transaction segment or (b) the second critical threshold associated with the second transaction segment; and
in response to a determination that the current operational data exceeds the first critical threshold or the second critical threshold, electronically generate an alert indicating that a critical threshold has been exceeded.

2. The system of claim 1 wherein the one or more processors are further configured to electronically generate impact data in response to an alert indicating that the current operational data exceeds the first critical threshold or the second critical threshold, and wherein the impact data projects how the current operational data affects the business process.

3. The system of claim 2 wherein the one or more processors are further configured to generate a unique electronic signature associated with the business process based on the past operational data associated with the first and second transaction segments respectively.

4. The system of claim 1 wherein the one or more processors are further configured to electronically associate (a) a first predictive threshold with the first transaction segment and (b) a second predictive threshold with the second transaction segment.

5. The system of claim 4 wherein the one or more processors are further configured to:
electronically determine if the current operational data exceeds (a) the first predictive threshold associated with the first transaction segment or (b) the second predictive threshold associated with the second transaction segment; and
in response to a determination that the current operational data exceeds the first predictive threshold or the second predictive threshold, electronically generate an alert indicating that a predictive threshold has been exceeded.

6. The system of claim 5 wherein the one or more processors are further configured to electronically generate impact data in response to the current operational data exceeding the first predictive threshold or the second predictive threshold, and wherein the impact data projects how the current operational data affects the business process.

7. The system of claim 1 wherein the unique electronic signature associated with the first transaction segment and the unique electronic signature associated with the second transaction segment are displayed as a graphical representation.

8. The system of claim 1 wherein the one or more processors are further configured to:
associate (a) a first degradation threshold with the first transaction segment and (b) a second degradation threshold with the second transaction segment;
electronically determine if the current operational data exceeds (a) the first degradation threshold associated with the first transaction segment or (b) the second degradation threshold associated with the second transaction segment; and
in response to a determination that the current operational data exceeds the first degradation threshold or the second degradation threshold, electronically generate an alert indicating that a degradation threshold has been exceeded.

9. The system of claim 8 wherein the one or more processors are further configured to electronically generate impact data in response to the current operational data exceeding the first degradation threshold or the second degradation threshold, and wherein the impact data projects how the current operational data affects the business process.

10. The system of claim 9 wherein the alert indicates that the second transaction segment cannot be initiated because of the degradation.

11. The system of claim 1 wherein the past operational data associated with the first and second transaction segments respectively, includes transaction volume information over a fixed period of time.

12. The system of claim 11 wherein the current operational data associated with the first and second transaction segments respectively, includes current transaction volume information.

13. The system of claim 12 wherein:
the current operational data includes data associated with the respective transactions being processed via the business process,
the data associated with the respective transactions provides an indication if a status of a transaction has changed from a first status to a second status, and
the first status indicates the transaction is in the first transaction segment and the second status indicates the transaction is in the second transaction segment.

14. A computer program product comprising at least one computer-readable storage medium having computer-readable program code portions stored therein, the computer-readable program code portions comprising:
a first executable portion configured to receive input identifying a first transaction segment and a second transaction segment of a business process;
a second executable portion configured to electronically receive (a) past operational data associated with the first transaction segment and (b) past operational data associated with the second transaction segment;
a third executable portion configured to electronically generate (a) a unique electronic signature associated with the first transaction segment based on the past operational data associated with the first transaction segment and (b) a unique electronic signature associated with the second transaction segment based on the past operational data associated with the second transaction segment;
a fourth executable portion configured to electronically associate (a) a first critical threshold with the first transaction segment and (b) a second critical threshold with the second transaction segment;
a fifth executable portion configured to electronically receive (a) current operational data associated with the first transaction segment and (b) current operational data associated with second transaction segment;
a sixth executable portion configured to electronically determine if the current operational data exceeds (a) the first critical threshold associated with the first transaction segment or (b) the second critical threshold associated with the second transaction segment; and
a seventh executable portion configured to electronically generate an alert indicating that a critical threshold has been exceeded in response to a determination that the current operational data exceeds the first critical threshold or the second critical threshold.

15. The computer program product of claim 14 further comprising an eighth executable portion configured to electronically generate impact data in response to an alert indicating that the current operational data exceeds the first critical threshold or the second critical threshold, and wherein the impact data projects how the current operational data affects the business process.

16. The computer program product of claim 15 further comprising a ninth executable portion configured to generate a unique electronic signature associated with the business process based on the past operational data associated with the first and second transaction segments respectively.

17. The computer program product of claim 14 further comprising an eighth executable portion configured to electronically associate (a) a first predictive threshold with the first transaction segment and (b) a second predictive threshold with the second transaction segment.

18. The computer program product of claim 17 further comprising:
a ninth executable portion configured to electronically determine if the current operational data exceeds (a) the first predictive threshold associated with the first transaction segment or (b) the second predictive threshold associated with the second transaction segment; and
a tenth executable portion configured to electronically generate an alert indicating that a predictive threshold has been exceeded in response to a determination that the current operational data exceeds the first predictive threshold or the second predictive threshold.

19. The computer program product of claim 18 further comprising an eleventh executable portion configured to generate impact data in response to the current operational data exceeding the first predictive threshold or the second predictive threshold, and wherein the impact data projects how the current operational data affects the business process.

20. The computer program product of claim 14 wherein the unique electronic signature associated with the first transaction segment and the unique electronic signature associated with the second transaction segment are displayed as a graphical representation.

21. The computer program product of claim 14 further comprising:
an eighth executable portion configured to associate (a) a first degradation threshold with the first transaction segment and (b) a second degradation threshold with the second transaction segment;
a ninth executable portion configured to electronically determine if the current operational data exceeds (a) the first degradation threshold associated with the first transaction segment or (b) the second degradation threshold associated with the second transaction segment; and
a tenth executable portion configured to electronically generate an alert indicating that a degradation threshold has been exceeded in response to a determination that the current operational data exceeds the first degradation threshold or the second degradation threshold.

22. The computer program product of claim 21 further comprising an eleventh executable portion configured to electronically generate impact data in response to the current operational data exceeding the first degradation threshold or the second degradation threshold, and wherein the impact data projects how the current operational data affects the business process.

23. The computer program product of claim 22 wherein the alert indicates that the second transaction segment cannot be initiated because of the degradation.

24. The computer program product of claim 23 wherein the past operational data associated with the first and second transaction segments respectively, includes transaction volume information over a fixed period of time.

25. The computer program product of claim 24 wherein the current operational data associated with the first and second transaction segments respectively, includes current transaction volume information.

26. The computer program product of claim 25 wherein:
the current operational data includes data associated with the respective transactions being processed via the business process,
the data associated with the respective transactions provides an indication if a status of a transaction has changed from a first status to a second status, and
the first status indicates the transaction is in the first transaction segment and the second status indicates the transaction is in the second transaction segment.
